(19) United States
(12) Patent Application Publication
(10) Pub. No.: US 2014/0131151 A1
(43) Pub. Date: May 15, 2014

(54) Bicycle Disc Brake Rotors and Methods of Making and Using the Same

(71) Applicants: Joshua R. Gore, McHenry, IL (US); Aaron A. Stephens, Bartlett, IL (US)

(72) Inventors: Joshua R. Gore, McHenry, IL (US); Aaron A. Stephens, Bartlett, IL (US)

(21) Appl. No.: 13/677,865

(22) Filed: Nov. 15, 2012

(51) Int. Cl. B60T 1/06; B29D 99/00

(52) U.S. Cl. CPC B60T 1/065; B29D 99/0032
USPC 188/218 XL; 264/257; 156/242

(57) ABSTRACT

Bicycle disc brake rotors of the present invention are lightweight, have relatively high coefficients of friction to maintain braking friction under heavy braking, and quickly shed heat. The parts may preferably be made from a compound having carbon fiber and/or a refractory material, such as ceramic filler, within a polycarbosilane polymer resin, the polymer resin having a silicon-oxygen polymer backbone, producing silicon oxycarbides upon pyrolysis. Methods of making and using the same are further provided.

### TECHNICAL FIELD

The present invention relates to bicycle disc brake rotors. Specifically, the present invention relates to bicycle disc brake rotors that are lightweight, have relatively high coefficients of friction to maintain braking friction under heavy braking, quickly shed heat, and lessen unsprung mass and/or the rotational weight of the bicycle. More specifically, the present invention relates to the braking surface and supporting member thereof made from compositions as described herein, thereby reducing time and costs of manufacture. The parts may preferably be made from a compound having carbon fiber and/or a refractory material, such as ceramic filler, within a polycarbosilane polymer resin, the polymer resin having a silicon-oxygen polymer backbone, producing silicon oxycarbides upon pyrolysis. Methods of making and using the same are further provided.

### BACKGROUND

It is, of course, generally known to utilize relatively strong materials to manufacture a bicycle disc brake rotor. Indeed, a typical material utilized is steel. However, while relatively strong, steel tends to be very heavy, and suffers from retaining heat that may be generating during heavy braking. Moreover, increased weight of brake rotors increases the unsprung mass and/or the rotational weight of the bicycle, contributing to a decrease in grip of the tires on the roadway surface, and a decrease in control of the bicycle, especially over rough terrain.

To decrease the weight of steel brake rotors, milling the brake rotor surface has been done to remove mass from the brake rotor. However, milling of the surface may introduce points of weakness in the brake rotor, contributing to cracking of the same under high heat or other duress. Moreover, milling the brake rotor surface may decrease the effective friction area of the brake rotor contributing to a lessening of the brake rotor braking capability.

Other materials have been proposed for use in bicycle disc brake rotors to decrease the weight of the brake rotors. For example, Shimano® utilizes an aluminum disc rotor having layers of stainless steel and aluminum in an attempt to both decrease the weight and more quickly cool the braking surface under heavy braking. However, imperfections in the material may contribute to delamination of the layers, and while the resultant layers may dissipate heat more quickly than just steel, heavy braking may still contribute to problems associated with heat retention.

Polyamide and polyimide materials have been proposed for use in bicycle brake rotors, but these materials, by themselves, tend to have low coefficients of friction of the braking surface, decreasing the braking capability of bicycle disc brake rotors made from the same. Braking rotors made from carbon composites, such as typically used in automobiles, have also been proposed for bicycle use but these materials have a high cost of manufacture and may contain metal particulates that may retain heat under heavy brake use.

Thus, a need exists for bicycle disc brake rotors and methods of making and using the same that are relatively low weight, contributing to an overall decrease in weight of the bicycles. More specifically, a need exists for bicycle disc brake rotors and methods of making and using the same that contributes to a relatively low unsprung mass and/or rotational weight for bicycles, allowing an individual better control of the bicycles.

Further, a need exists for bicycle disc brake rotors and methods of making and using the same that allows for the dissipation of heat more readily than heretofore known solutions. Still further, a need exists for bicycle brake disc rotors and methods of making the same that increase efficiency by ensuring that the disc brake rotor braking surface dissipates heat effectively throughout braking, and specifically during heavy braking.

Moreover, a need exists for bicycle disc brake rotors and methods of making and using the same that provide relatively high coefficients of friction thereby maintaining braking friction, such as during periods of heavy use. A need further exists for bicycle disc brake rotors and methods of making and using the same that may be molded into various shapes, without compromising performance properties of the brake rotors.

And, a need exists for bicycle disc brake rotors and methods of making and using the same that are relatively inexpensive to manufacture, and minimizes waste material. Further, a need exists for bicycle disc brake rotors and methods of making and using the same that may be manufactured relatively quickly, and without further milling or other processes.

### SUMMARY OF THE INVENTION

The present invention relates to bicycle disc brake rotors. Specifically, the present invention relates to bicycle disc brake rotors that are lightweight, have relatively high coefficients of friction to maintain braking friction under heavy braking, quickly shed heat, and lessen unsprung mass and/or the rotational weight of the bicycle. More specifically, the present invention relates to the braking surface and supporting member thereof made from compositions as described herein, thereby reducing time and costs of manufacture. The parts may preferably be made from a compound having carbon fiber and/or a refractory material, such as ceramic filler, within a polycarbosilane polymer resin, the polymer resin having a silicon-oxygen polymer backbone, producing silicon oxycarbides upon pyrolysis. Methods of making and using the same are further provided.

To this end, in an embodiment of the present invention, a bicycle disc brake rotor is provided comprising a braking surface adapted to engage a brake pad on a bicycle for braking the bicycle, the braking surface made from a polymer ceramic carbon fiber composite material made from a polymeric resin, ceramic particles and carbon fibers.

In an embodiment, the carbon fibers are randomly oriented within the polymeric resin.

In an embodiment, the polymer ceramic carbon fiber composite material is made from a thermoset polymer.

In an embodiment, the polymer ceramic carbon fiber composite material is made from a polycarbosilane resin.

In an embodiment, the polycarbosilane resin is pyrolyzed.

In an embodiment, the braking surface is made from a weave of the polymer carbon fiber composite material.

In an embodiment, the bicycle disc brake rotor further comprises a support member supporting the braking surface and interconnected with the braking surface.

In an embodiment, the support member is selected from the group consisting of steel, aluminum, an alloy of steel, an alloy of aluminum, polymer resins, and blends thereof.

In an embodiment, the support member is made from a polymer resin selected from the group consisting of a thermoplastic, a thermoset, an epoxy, and blends thereof.

In an embodiment, the support member further comprises an amount of carbon fibers embedded therein

In an embodiment, the carbon fibers are randomly oriented.

In an embodiment, the support member is made from a vinyl ester having randomly oriented carbon fibers embedded therein.

In an embodiment, a bicycle comprises the disc brake rotor as defined heretofore.

In an alternate embodiment of the present invention, a method of making a bicycle disc brake rotor is provided. The method comprises the step of: forming a braking surface made from a polycarbosilane resin embedded with carbon fibers and ceramic particles.

In an embodiment, the method further comprises pyrolyzing the polycarbosilane resin embedded with carbon fibers and ceramic particles into a ceramic material.

In an embodiment, the step of forming the braking surface comprises the steps of: cutting a weave of polycarbosilane resin embedded with carbon fibers and ceramic particles into a plurality of plies having the same general shape; stacking the plies together to form a preform; heating the preform under increased pressure; and pyrolyzing the preform at increased temperature.

In an embodiment, the method further comprises: prior to pyrolyzing the preform at increased temperatures, filling open pore spaces within the braking surface with polycarbosilane resin; and further wherein the step of pyrolyzing the preform at increased temperatures comprises pyrolyzing the polycarbosilane resin added to fill the open pore spaces of the braking surface.

In an embodiment, the method further comprises: providing a support member for the braking surface made from a material selected from the group of steel, aluminum, an alloy of steel, an alloy of aluminum, polymer resins, and blends thereof; and interconnecting the support member to the braking surface.

In an embodiment, the support member is made using a polymer resin selected from the group consisting of a thermoplastic, a thermoset, an epoxy, and blends thereof.

In an embodiment, the support member includes an amount of carbon fibers embedded therein.

It is, therefore, an advantage and objective of the present invention to provide bicycle disc brake rotors and methods of making and using the same that are relatively low weight, contributing to an overall decrease in weight of the bicycles.

More specifically, it is an advantage and objective of the present invention to provide bicycle disc brake rotors and methods of making and using the same that contribute to a relatively low unsprung mass and/or rotational weight for bicycles, allowing an individual better control of the bicycles.

Further, it is an advantage and objective of the present invention to provide bicycle disc brake rotors and methods of making and using the same that allows for the dissipation of heat more readily than heretofore known solutions.

Still further, it is an advantage and objective of the present invention to provide bicycle disc brake rotors and methods of making the same that increase efficiency by ensuring that the brake rotor braking surface sheds heat effectively throughout braking, and specifically during heavy braking.

Moreover, it is an advantage and objective of the present invention to provide bicycle disc brake rotors and methods of making and using the same that provides relatively high coefficients of friction thereby maintaining braking friction, such as during periods of heavy use.

It is a further advantage and objective of the present invention to provide bicycle disc brake rotors and methods of making and using the same that may be molded into various shapes, without compromising performance properties of the brake rotors.

And, it is an advantage and objective of the present invention to provide bicycle disc brake rotors and methods of making and using the same that are relatively inexpensive to manufacture, and minimizes waste material.

Further, it is an advantage and objective of the present invention to provide bicycle disc brake rotors and methods of making and using the same that may be manufactured relatively quickly, and without further milling or other processes.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a bicycle disc brake rotor comprising a braking surface and a support structure in an embodiment of the present invention.

FIG. 2 illustrates a bicycle disc brake rotor comprising an integrated braking surface and support structure in an embodiment of the present invention.

FIG. 3 illustrates a bicycle disc brake rotor comprising an integrated braking surface and support structure in an embodiment of the present invention.

### DETAILED DESCRIPTION OF THE PRESENTLY PREFERRED EMBODIMENTS

The present invention relates to bicycle disc brake rotors. Specifically, the present invention relates to bicycle disc brake rotors that are lightweight, have relatively high coefficients of friction to maintain braking friction under heavy braking, quickly shed heat, and lessen unsprung mass and/or the rotational weight of the bicycle. More specifically, the present invention relates to the braking surface and supporting member thereof made from compositions as described herein, thereby reducing time and costs of manufacture. The parts may preferably be made from a compound having carbon fiber and/or a refractory material, such as ceramic filler, within a polycarbosilane polymer resin, the polymer resin having a silicon-oxygen polymer backbone, producing silicon oxycarbides upon pyrolysis. Methods of making and using the same are further provided.

A disc brake rotor, also known as and referred to herein as a disc brake, of the present invention is generally positioned on a rear wheel and/or a front wheel of a bicycle for engaging with one or more calipers to slow and/or stop the bicycle. A disc brake rotor may generally consist of a disc attached to a wheel hub of a bicycle that rotates with the wheel as the wheel spins during use of the bicycle. One or more calipers may be attached to the frame or fork of the bicycle along with one or more pads that may engage the disc when braking, typically via a brake lever accessible to the rider. As the pad or pads drag against the disc, the wheel, and thus the bicycle, may be slowed as kinetic energy in the form of motion is transformed into thermal energy. A bicycle disc brake rotor may be mechanically actuated, as with a Bowden cable, or hydraulically actuated, or a combination of the two.

A disc brake rotor may have a number of advantages, as compared to other braking systems, such as rim brakes. Specifically, a disc brake rotor, positioned near the hub of a bicycle wheel, is further from the rim and the tire, such that debris, mud, ice or other buildup that may be on the rim or tire may not interfere with the disc rotor and caliper. In addition, because heat is generated by braking, the heat is not transferred into the tire, as with a rim brake. The disc brake rotor itself may have holes therein for allowing water or debris to flow therethrough, minimizing the possibility of interference during braking. Moreover, the calipers may be placed relatively close to the disc brake rotor, increasing the efficiency of braking and minimizing or preventing the buildup of debris on the brake pad. Wear that may occur during braking may be on the disc brake rotor, and not on the rim of the bike. The disc brake rotor may be easier and less costly to replace when worn compared to the rim. However, a major disadvantage of typical disc brake rotors are that they are relatively heavy compared to rim brakes, and heat buildup on the discs may cause warping or failing of the discs.

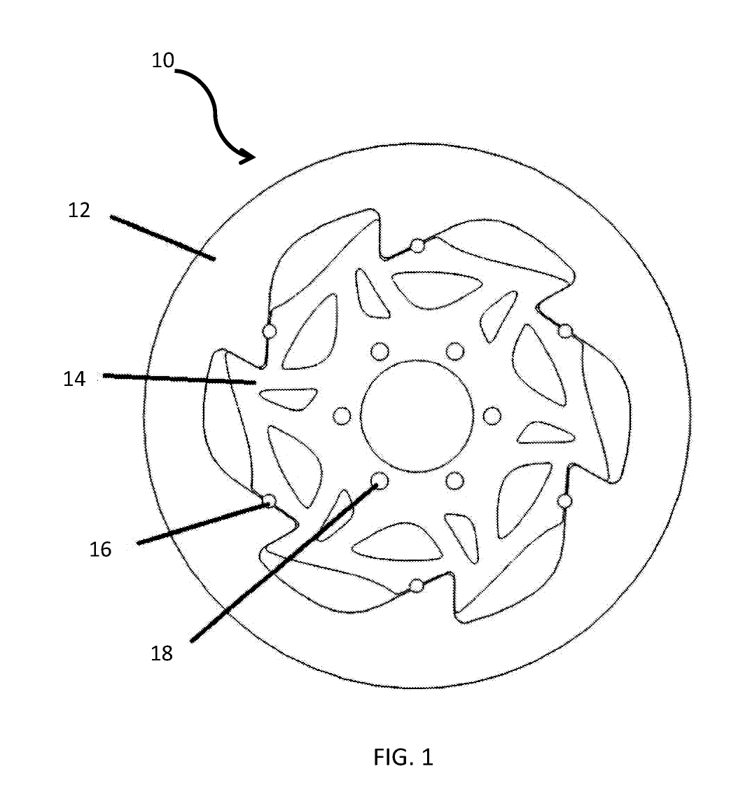

The present invention provides a disc brake rotor that is relatively lightweight and strong, with high heat dissipating properties. Now referring to the figures, wherein like numerals refer to like parts, FIG. 1 illustrates an example of a disc brake rotor 10 of the present invention. Specifically, the disc brake rotor 10 may include a braking surface 12 forming a generally circular disc-shaped surface for engaging with one or more calipers for braking. Within the braking surface 12 may be a support member 14 (also known as a “spider”), and the support member 14 may be connected to the braking surface 12 via fasteners 16, such as bolts, rivets, screws, or other like fasteners, as apparent to one of ordinary skill in the art. On the support member 14 may be mounting holes 18 for mounting the disc brake rotor 10 to a wheel hub, as is apparent to one of ordinary skill in the art.

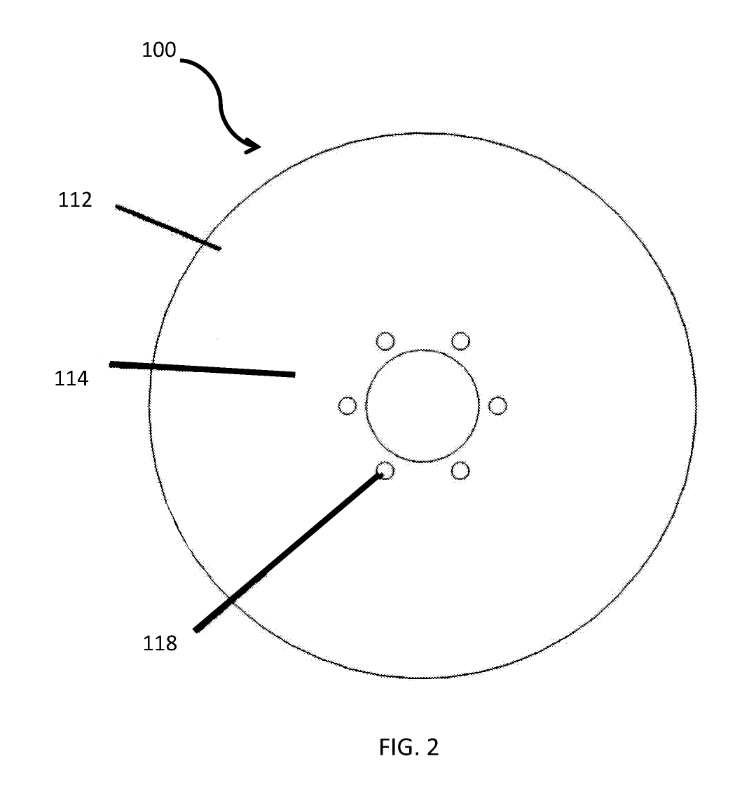

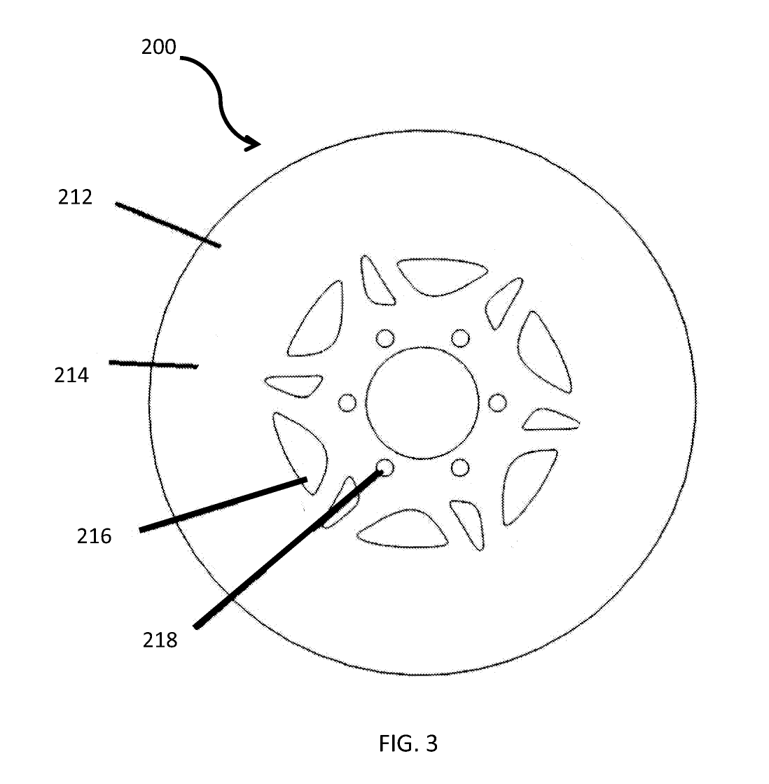

FIGS. 2 and 3 illustrate additional embodiments of disc brake rotors 100 and 200, respectively, in alternate embodiments of the present invention. While the disc brake rotor 10, as disclosed above in FIG. 1, may include a separate braking surface 12 and support member 14, the brake rotors 100, 200 may be integrally formed, such that the braking surface and any support structure may be the same material, as described below. Thus, the disc brake rotors 100 and 200 may advantageously be easier and less costly to manufacture.

As illustrated in FIG. 2, the disc brake rotor 100 may have a braking surface 112 and an integrally formed support member 114, and may be a solid disc of material, as described herein, with no holes, windows, apertures, designs or other significant details provided therein, apart from mounting holes 118 that may allow the disc brake rotor 100 to be mounted on a bicycle. FIG. 3 illustrates an integrated disc brake rotor having a braking surface 212 and an integrally formed support member 214 having a plurality of windows or voids 216 therein, and mounting holes 218. The windows or voids 216 provide a distinctive design pattern, but more importantly and functionally allow for the decrease in the weight of a comparable disc brake rotor without the windows or voids disposed therein, such as the disc brake rotor shown and described with reference to FIG. 2. Of course, it should be noted that the disc brake rotors of the present invention may have any pattern of windows, voids, holes, depressions, raised surfaces, or other like design features, and the present invention should not be limited as described herein.

### Braking Surface

The braking surface 12 may preferably be made of a ceramic material formed within a polymer resin and further with carbon fibers embedded therein, referred to herein as a polymer ceramic carbon fiber composite material. Specifically, the ceramic material may preferably be made using a polycarbosilane thermoset resin to form the braking surface via a compression molding process. Specifically, the thermoset resin forming the braking surface 12 may be made from a polycarbosilane material disclosed in U.S. Pat. No. 7,714,092 to Shen, which is incorporated herein by reference in its entirety. Upon pyrolysis, a silicon carbide ceramic may be formed. Preferably, the polycarbosilane resin is filled with discontinuous carbon fibers (also known as random bulk carbon fibers). These fibers may be any size, however, randomly-oriented 1 inch or longer carbon fibers may be preferred. Additionally, the polycarbosilane resin may be filled with a refractory material, such as ceramic filler, such as ceramic particles, or other filler. Upon pyrolysis, the braking surface may be lightweight, strong, and have a high coefficient of friction for use as a braking surface.

In a method of manufacturing the braking surface 12, integrally formed disc brake rotor 100 and/or integrally formed disc brake rotor 200 (heretofore known as “the part”), the part may be made by compression molding the resin material, bulk carbon fibers, and refractory material, such as ceramic filler, to pyrolyze the part. The compression molding may be repeated several times to produce the finished product having the preferred weight and/or density. Specifically, in an embodiment of the present invention, the braking surface may be formed in a mold having a top mold portion and a bottom mold portion, and the part formed within a void between the top mold portion and the bottom mold portion. In a first step, a polycarbosilane matrix forming polymer, as described in U.S. Pat. No. 7,714,092 to Shen, may be embedded with the random bulk carbon fibers and/or refractory material, such as ceramic filler, as described above, and may be placed within the mold to form an initial thermoset part upon the application of heat and pressure, thereby pyrolyzing the polycarbosilane matrix forming polymer. Upon pyrolysis, under heat and pressure in an inert atmosphere, the matrix polymer may form a body which may further be densified via polymer infiltration and pyrolysis (“PIP”), as described below.

Alternatively, a weave or fabric impregnated with the resin and refractory material, such as ceramic particles, may be cut into a desired shape, such as the shapes illustrated in FIGS. 1-3. Several plies of the weave or fabric may be cut and staked to make a preform of generally the appropriate sized and thickness of the part. The preform may then be heated under pressure to produce a near-net shape. Pyrolysis of the weave at appropriate temperatures and pressures may convert the polymer to silicon carbide, shrinking the matrix and increasing its density.

Specifically, densification of the pyrolyzed matrix polymer (whether formed using bulk composite material or weave/fabric) may be accomplished by filling the open porosity of the part with polycarbosilane infiltration polymer, as described in U.S. Pat. No. 7,714,092 to Shen via vacuum infiltration. The part is again pyrolyzed under heat and pressure in an inert environment to form the ceramic, thereby shrinking in volume but increasing in density, forming, yet again, open porosity within the part. The open porosity of the part is again filled via vacuum infiltration with polycarbosilane infiltration polymer, as described above, and pyrolyzed under heat and pressure in an inert atmosphere. Filling of the open porosity with polycarbosilane polymer and pyrolyzing the same may be done repeatedly until the part forms the braking surface 12, integrally-formed braking surface 100 and/or integrally-formed braking surface 200, as described above, having the desired weight and/or density. A summary of the filling and pyrolyzation of the braking surface 12 may be found at www.starfiresystems.com/pip-process.html, which is incorporated herein by reference in its entirety. The part may then be milled, as desired, into a final shape.

In a preferred embodiment of the present invention, a silicon oxycarbides refractory filled slurry known as SL-680 from Starfire Systems may be impregranted in a bulk fiber compound made of chopped carbon fibers or impregnated into a carbon fiber weave. If impregnated into a bulk fiber compound, the slurry and bulk fiber compound may be formed or molded into the shape of the part (so-called “neat net shape”), as disclosed herein and heated to 325° C. until the part is cured to form a thermoset. Alternatively, if impregnated into a carbon fiber weave, the weave may be cut or machined into, generally, the near net shape of the part and heated to 325° C. until the near net shape of the part forms a thermoset. The cured part may then be infiltrated by a polycarbosilane liquid known as Polyramic® SPR-212 supplied by Starfire Systems by immersing the near net shape of the part in a bath of SPR-212 within a vacuum chamber. Optionally, the part may sit within a bath of SPR-212 without application of the vacuum.

After infiltration of the part with SPR-212 polycarbosilane liquid, the part may be cured by heating in an oven in an inert atmosphere of nitrogen or argon to cure the same, causing pyrolysis of the part. After cooling, the part is weighed and the part may be infiltrated with SPR-212 and heated again to pyrolyze the part until the part achieves the target density requirements. Upon achieving the required density, the part may be finished to its final shape, ensuring that the part meets differential thickness requirements. Preferably, the part, as described herein, may have a differential thickness variation of less than about 0.00005. The part may also be finished to ensure the part mates properly with mating parts.

Referring to FIG. 1, the braking surface 12, thus, may be relatively lightweight and sufficiently heat-resistant and heat-dissipating such that the braking surface may be utilized in a disc brake rotor on a bicycle, as described herein. Of course, the braking surface 12 may be any shape that may mate with the support member 14, and may be created with voids therein to even further decrease the weight thereof. Utilization of the polycarbosilane resin may allow for a plurality of designs for the braking surface 12. Voids, differences in cross-sectional thickness or density of the part, or other differences throughout the braking surface should have little to no effect on the strength and the braking properties of the braking surface 12.

### Support Member

The support member 14 of the present invention may be any shape as apparent to one of ordinary skill in the art, but must both mate with the braking surface 12 and be connected therewith, and also be attached to the hub of a bicycle wheel through the mounting holes 18. In general, the support member 14 may be steel, alloy steel, alloy aluminum, or any other material known to one of ordinary skill in the art to provide support for the braking surface 12 and attachment to the wheel hub.

In a preferred embodiment, the support member 14 may be made with a compression molded polymer resin filled with carbon fibers, whether randomly oriented, weave or unidirectional. The polymer resin may be a thermoplastic, thermoset or epoxy resin. Preferably, the polymer resin may be filled with randomly oriented carbon fibers. More preferably, the polymer resin may be filled with 1 inch or longer randomly oriented carbon fibers. A preferable material may be Quantum Composites AC8590, which is a vinyl ester impregnated with chopped randomly-oriented carbon fibers, to form a carbon fiber reinforced Engineered Structural Composite (ESC) molding compound. The AC8590 is easily moldable and may provide a support member 14 that is high strength, fatigue resistant, with high heat resistance and low density.

In a preferred method of manufacture, the support member 14 may be made via compression molding of the carbon fiber-filled resin. Specifically, a top mold portion and a bottom mold portion may form a mold void therebetween when disposed together. The bottom mold portion may be filled with strips, segments, or other relatively small portions of the carbon fiber-filled resin. Preferably, if the resin is Quantum Composites AC8590, which may be utilized in sheet form, the sheet may be cut into strips or other shapes and placed within the bottom mold portion. Alternatively, the general shape of the support member 14, to fit the mold, may be stamped from the sheet of the AC8590, or other material, and placed within the bottom mold portion. Of course, the mold portions may be provided with mold release to ensure that the part easily releases therefrom.

Care must be taken to ensure that a sufficient amount of carbon fiber-filled resin is utilized in the mold without providing too much. However, should not enough resin be placed within the mold, additional carbon fiber-filled resin may be placed therein, and the mold may be re-compressed. If too much resin is provided, then additional resin may be trimmed from the part. In addition, while different resins may have different requirements, the AC8590 is recommended to be placed within mold portions that match platen temperatures of the press.

After placing the carbon fiber-filled resin within the bottom mold portion, the top mold portion may be placed thereon and pressed at a high temperature. For AC8590, the mold may be pressed at a temperature of between about 260 degrees F. and about 310 degrees F. It has been found that a temperature of 285 degrees F. is most preferred, with a pressure of about 5 tons for approximately ten minutes. Once completed, the mold may be removed from the press, and the part may be removed from the mold, such as using a secondary ejection press, for example. Thus, the part may be ejected from the mold.

Upon quality testing, it may be determined that the part may have insufficient forming. In such a case, the part may be added back to the mold, and additional carbon fiber-filled resin may be placed therein. The above steps may then be repeated to form the final product. Alternatively, another support member may be created with additional carbon fiber-filled resin using the mold, via the steps identified above. The finished support member 14 may be finished and attached to the braking surface 12, as described in more detail below.

The support member 14, therefore, may be formed having exceptional strength, heat resistance, heat dissipation, and fatigue life. Indeed, imperfections, such as holes and defects in the final part generally do not have any effect on the properties of the support member 14. In addition, the support member 14 may be manufactured in any shape, including complex 3D shapes, and shapes having abrupt changes in cross-section thickness without impacting the properties of the support member 14. In an alternative embodiment, finish may be placed within the mold during compression to product the support member 14 having a surface finish thereon.

### Disc Brake Rotor

The disc brake rotor 10 of the present invention may thus include the braking surface 12 interconnected with the support member 14 via fasteners 16, such as rivets that may or may not have washers, as apparent to one of ordinary skill in the art. The disc brake rotor 10 may, as a whole, be lightweight, have high strength, high temperature dissipating properties. Unsprung mass of the resultant bicycle may also be lessened, leading to more control of the bicycle over rough terrain. The disc brake rotor 10 may be placed upon a bicycle wheel hub, as apparent to one having ordinary skill in the art, and utilized thereon.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A bicycle disc brake rotor comprising:
a braking surface adapted to engage a brake pad on a bicycle for braking the bicycle, the braking surface made from a polymer ceramic carbon fiber composite material made from a polymeric resin, ceramic particles and carbon fibers.

2. The bicycle disc brake rotor of claim 1 wherein the carbon fibers are randomly oriented within the polymeric resin.

3. The bicycle disc brake rotor of claim 1 wherein the polymer ceramic carbon fiber composite material is made from a thermoset polymer.

4. The bicycle disc brake rotor of claim 1 wherein the polymer ceramic carbon fiber composite material is made from a polycarbosilane resin.

5. The bicycle disc brake rotor of claim 3 wherein the polycarbosilane resin is pyrolyzed.

6. The bicycle disc brake rotor of claim 1 wherein the braking surface is made from a weave of the polymer carbon fiber composite material.

7. The bicycle disc brake rotor of claim 1 further comprising:
a support member supporting the braking surface and interconnected with the braking surface.

8. The bicycle disc brake rotor of claim 7 wherein the support member is selected from the group consisting of steel, aluminum, an alloy of steel, an alloy of aluminum, polymer resins, and blends thereof.

9. The bicycle disc brake rotor of claim 8 wherein the support member is made from a polymer resin selected from the group consisting of a thermoplastic, a thermoset, an epoxy, and blends thereof.

10. The bicycle disc brake rotor of claim 9 wherein the support member further comprises an amount of carbon fibers embedded therein

11. The bicycle disc brake rotor of claim 10 wherein the carbon fibers are randomly oriented.

12. The bicycle disc brake rotor of claim 7 wherein the support member is made from a vinyl ester having an amount of randomly oriented carbon fibers embedded therein.

13. A bicycle comprising the disc brake rotor of claim 1.

14. A method of making a bicycle disc brake rotor comprising the steps of:
forming a braking surface made from a polycarbosilane resin embedded with carbon fibers and ceramic particles.

15. The method of claim 14 further comprising:
pyrolyzing the polycarbosilane resin embedded with carbon fibers and ceramic particles into a ceramic material.

16. The method of claim 14 wherein the step of forming the braking surface comprises the steps of:
cutting a weave of polycarbosilane resin embedded with carbon fibers and ceramic particles into a plurality of plies having the same general shape;
stacking the plies together to form a preform;
heating the preform under increased pressure; and
pyrolyzing the preform at increased temperature.

17. The method of claim 14 further comprising:
prior to pyrolyzing the preform at increased temperatures, filling open pore spaces within the braking surface with polycarbosilane resin, and further wherein the step of pyrolyzing the preform at increased temperatures comprises pyrolyzing the polycarbosilane resin added to fill the open pore spaces of the braking surface.

18. The method of claim 14 further comprising:
providing a support member for the braking surface made from a material selected from the group of steel, aluminum, an alloy of steel, an alloy of aluminum, polymer resins, and blends thereof; and
attaching the support member to the braking surface.

19. The method of claim 17 wherein the support member is made using a polymer resin selected from the group consisting of a thermoplastic, a thermoset, an epoxy, and blends thereof.

20. The method of claim 18 wherein the support member includes an amount of carbon fibers embedded therein.
